(19) United States
(12) Patent Application Publication
(10) Pub. No.: US 2005/0106916 A1
(43) Pub. Date: May 19, 2005

(54) Connector

(75) Inventor: Yoshiyuki Nomura, Mie (JP)

Correspondence Address: OLIFF & BERRIDGE, PLC, P.O. BOX 19928, ALEXANDRIA, VA, 22320, US

(73) Assignees: AUTONETWORKS TECHNOLOGIES, LTD., Yokkaichi-shi (JP); SUMITOMO WIRING SYSTEMS, LTD., Yokkaichi-shi (JP); SUMITOMO ELECTRIC INDUSTRIES, LTD., Osaka-shi (JP)

(21) Appl. No.: 10/969,922

(22) Filed: Oct. 22, 2004

(30) Foreign Application Priority Data
Oct. 27, 2003 (JP) 2003-366355
Oct. 27, 2003 (JP) 2003-366356

(51) Int. Cl. H01R 13/52

(52) U.S. Cl. 439/275

(57) ABSTRACT

A connector includes an electric wire; and a housing having at least one part where the electric wire is lead out from the housing. The at least one part is at least partially made of an elastic material having a stickiness. The elastic material independently seals the housing and the electric wire. When used for a long period of time under an environment at high temperature, a deterioration in a waterproofing function caused by using the silicone gel material can be avoided.

### BACKGROUND OF THE INVENTION

1. Field of the Invention

The present invention relates to a connector having a waterproofing function.

2. Description of the Related Art

There is a connector for waterproofing in which a lumped rubber plug in a flat plate shape comprising a silicone gel material is attached to a rear end face of a housing, a terminal metal piece is inserted into the housing from a rear side by penetrating the lumped rubber plug, and the lumped rubber plug is brought into close contact with an outer periphery of an electric wire connected to a rear end of the terminal metal piece to seal. When the lumped rubber plug comprising the silicone gel material is used, small pitch formation of the terminal metal piece can be dealt with and therefore, small-sized formation of the connector can be achieved. Further, there is a connector of this kind disclosed in JP-A-2002-237350.

In a press contact connector having a structure in which a press contact blade is attached to a case an upper face of which is opened, an electric wire is brought into press contact with the press contact blade, and a cover is covered on an upper face of the case to cover to conceal a press contact portion, waterproofing member described in JP-A-8-213097 can be devised. The waterproofing member is configured by a structure of interposing a rubber plug to a path of leading out the electric wire between the case and the cover and penetrating the electric wire through the rubber plug.

However, according to the structure, operation of passing the electric wire through the rubber plug is difficult and therefore, there is conceivable an waterproofing structure described below. According thereto, a housing side seal member for surrounding a group of press contact blades is attached to an upper face of a case, a cover side seal member in correspondence with the housing side seal member is attached to a lower face of a cover, and by integrating the cover to the case, the press-contacted electric wire is elastically squeezed in an up and down direction between the housing side seal member and the cover side seal member. According to the structure, troublesome operation of penetrating the electric wire to the rubber plug is not needed and therefore, the structure is excellent in operability.

There is a silicone gel material as a material of a seal member preferable for the interposing structure. The silicone gel material is provided with a property of easy to deform and therefore, there is achieved an advantage that it is not necessary to form a groove for fitting the electric wire to the seal member.

### SUMMARY OF THE INVENTION

When the lumped rubber plug comprising the silicone gel material as described above is used for a long period of time under an environment at high temperature, a permanent set in fatigue is brought about in the silicone gel material to lose an elastic force thereof and therefore, there is a concern of producing a clearance at a portion thereof penetrated by the electric wire.

The invention has been finished based on the above-described situation.

It is an object of the invention to provide a connector for waterproofing capable of dealing with small-sized formation and capable of withstanding a long period of use under an environment at high temperature.

According to first aspect of the invention, a connector including: an electric wire; and a housing having at least one part where the electric wire is lead out from the housing, wherein the at least one part is at least partially made of an elastic material having a stickiness, and the elastic material independently seals the housing and the electric wire. The at least one part can be sealed by the stickiness. When used for a long period of time under an environment at high temperature, a deterioration in a waterproofing function caused by using the silicone gel material can be avoided.

According to second aspect of the invention, the housing further includes; a lumped rubber plug; and a terminal metal piece connected to the electric wire at a rear end thereof. The lumped rubber plug seals to be brought into close contact with an outer periphery of the electric wire. The at least one part of the housing is configured by the lumped rubber plug.

Thus, the elastic material having the stickiness is brought into close contact with the outer periphery of the electric wire penetrating the lumped rubber plug and a clearance between the lumped rubber plug and the electric wire can firmly be prevented from being brought about by the sticking function. Further, since the silicone gel material is not used as a material of the lumped rubber plug, when used for a long period of time under an environment at high temperature, a deterioration of the waterproofing function caused by using the silicone gel material can be avoided.

According to third aspect of the invention, the lumped rubber plug comprises a sticky material made of an acrylic species resin.

Since the lumped rubber plug comprises the sticky material made of the acrylic species resin, the highly stable waterproofing function can be achieved under an environment requesting weather resistance and heat resistance. Further, according to the lumped rubber plug comprising the silicon gel material, sealing is carried out by filling the clearance between the lumped rubber plug and the electric wire by oil impregnated in the silicone gel and therefore, whereas there is a concern of deteriorating the sealing performance owing to denaturing and flowing out the oil, according to the invention, the sticky material made of the acrylic species resin is directly brought into close contact with the outer periphery of the electric wire by a sticking force of its own and therefore, the sealing performance can be maintained for a long period of time.

According to fourth aspect of the invention, the lumped rubber plug comprises a foamed material.

Since the lumped rubber plug comprises the foamed material, a sufficient thickness can be ensured and the waterproofing function can be provided by widening an area of sticking to the electric wire by that amount. Further, by forming the lumped rubber plug by the foamed material, an amount of elastically flexing the lumped rubber plug can sufficiently be ensured and therefore, the lumped rubber plug can firmly brought into close contact even with the electric wire having a large outer diameter.

According to fifth aspect of the invention, the lumped rubber plug is compressed to deform in an axis line direction of the electric wire between the housing and a holder.

Since the lumped rubber plug is compressed to deform to crush in the axial direction of the electric wire, a degree thereof of bringing the lumped rubber plug into close contact with the electric wire is increased and the sealing performance is promoted.

According to sixth aspect of the invention, the housing is formed with cavities aligning in at least one line. The lumped rubber plug is formed with slits along a direction of aligning the cavities. The terminal metal piece is contained in the cavities.

Thus, in inserting the terminal metal pieces into the cavities, positions of the cavities can be grasped by the optically observing the slits and therefore, operability in inserting the terminal metal pieces to the cavities is excellent. Further, in drawing out the terminal metal pieces inserted into the cavities once, operability in drawing out the terminal metal pieces from the cavities is excellent because a path of drawing out the terminal metal pieces is facilitated to be widened by forming the slits. Further, the clearance of the slit is eliminated by crushing the lumped rubber plug between the housing and the holder and therefore, the sealing performance is not deteriorated.

According to seventh aspect of the invention, the housing further includes; at least one press contact blade that brings into press contact with the electric wire; a cover having a cover side seal member at lower face thereof and covering upper opening face of the housing; and a housing side seal member corresponding to the cover side seal member that surrounds the at least one press contact blade at the upper opening face of the housing. The cover conceals a part where the electric wire is brought into press contact with the press contact blade. The press-contacted electric wire is elastically pinched between the housing side seal member and the cover side seal member. The at least one part of the housing is configured by the housing side seal member and the cover side seal member.

Thus, the elastic material having the stickiness is brought into close contact with the outer periphery of the electric wire and a clearance between the outer periphery and the housing side seal member and a clearance between the outer periphery and the cover side seal member can firmly be prevented from being brought about by a sticking function thereof. Further, since a silicone gel material is not used as a material of the seal members, when used for a long period of time under an environment at high temperature, a deterioration of a waterproofing function caused by using the silicon gel material can be avoided.

According to eighth aspect of the invention, the elastic comprise a sticky material made of an acrylic species resin.

Since the seal members comprise the sticky material made of the acrylic species resin, a highly stable waterproofing function can be achieved under an environment requesting weather resistance and heat resistance. Further, whereas according to a seal member comprising a silicon gel material, sealing is carried out by filling a clearance between the seal member and the electric wire by oil impregnated in the silicone gel and therefore, there is a concern of deteriorating the sealing performance owing to denaturing and flowing out the oil, according to the invention, the sticky material made of the acrylic species resin is directly brought into close contact with the outer periphery of the electric wire by a sticking force of its own and therefore, the sealing performance can be maintained for a long period of time.

According to tenth aspect of the invention, the elastic material comprises a foamed material.

By having the housing side seal member and cover side seal member by the foamed material, an amount of elastically flexing the seal members can sufficiently be ensured and therefore, the seal members can firmly brought into close contact even with the electric wire having a large diameter.

According to eleventh aspect of the invention, the elastic material is compressed to deform in a direction the same as a direction of pinching the housing side seal member and the cover side seal member to the electric wire.

Thus, the housing side seal member and the cover side seal member are compressed to deform to crush in the direction the same as the direction of squeezing the housing side seal member and the cover side seal member to the electric wire and therefore, a degree of brining the housing side seal member and the cover side seal member into close contact with the electric wire is increased and the sealing performance is promoted.

### BRIEF DESCRIPTION OF THE DRAWINGS

FIG. 1 is a sectional view showing a separated state of Embodiment 1;

FIG. 2 is a sectional view showing a state of containing a lumped rubber plug to a containing recessed portion and tackedly locking a holder to a housing;

FIG. 3 is a sectional view showing a state of inserting a terminal metal piece into the lumped rubber plug;

FIG. 4 is a sectional view of a state of finishing integration and elastically deforming the lumped rubber plug by the holder to seal an interval between the lumped rubber plug and the containing recessed portion;

FIG. 5 is a rear view of the housing;

FIG. 6 is a rear view of the lumped rubber plug;

FIG. 7 is a rear view showing a state of removing a sheet on a rear side of the lumped rubber plug;

FIG. 8 is a rear view showing a state of compressing the lumped rubber plug removed of the sheet on the rear side in an axial line direction of an electric wire;

FIG. 9 is a partially enlarged sectional view showing a structure of laminating the lumped rubber plug and the sheet;

FIG. 10 is a partially enlarged sectional view showing the structure of laminating the lumped rubber plug and the sheet compressed in the axial line direction of the electric wire;

FIG. 11 is a partially notched perspective view of a separated state of Embodiment 2 according to the invention;

FIG. 12 is a plane view of a case;

FIG. 13 is a bottom view of a cover;

FIG. 14 is a sectional view before integrating the case and the cover;

FIG. 15 is a sectional view of a state of integrating the cover to the case; and

FIG. 16 is a sectional view of a state of integrating the cover to the case;

### DESCRIPTION OF THE PREFERRED EMBODIMENTS

<Embodiment 1>

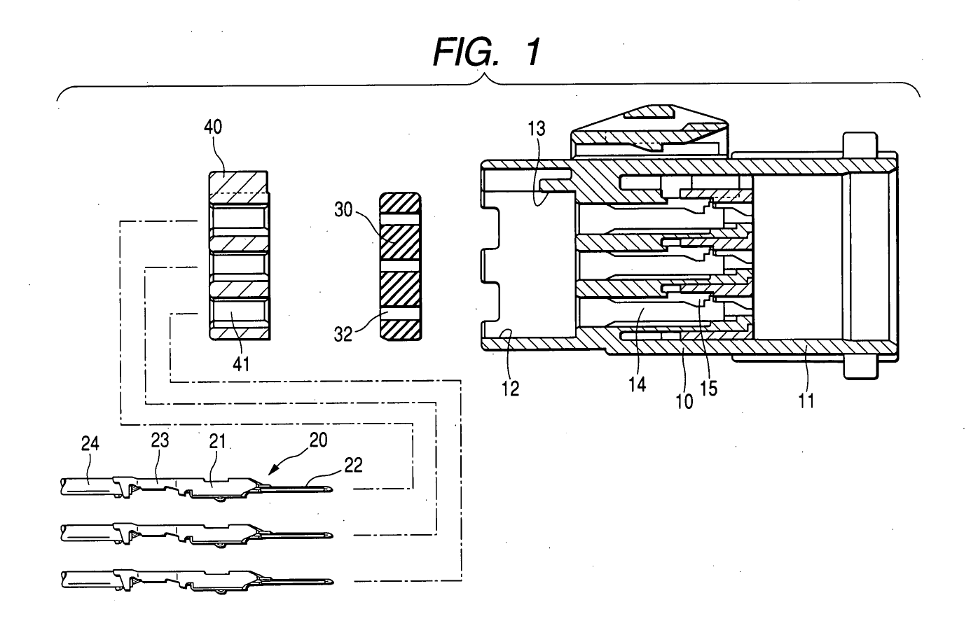

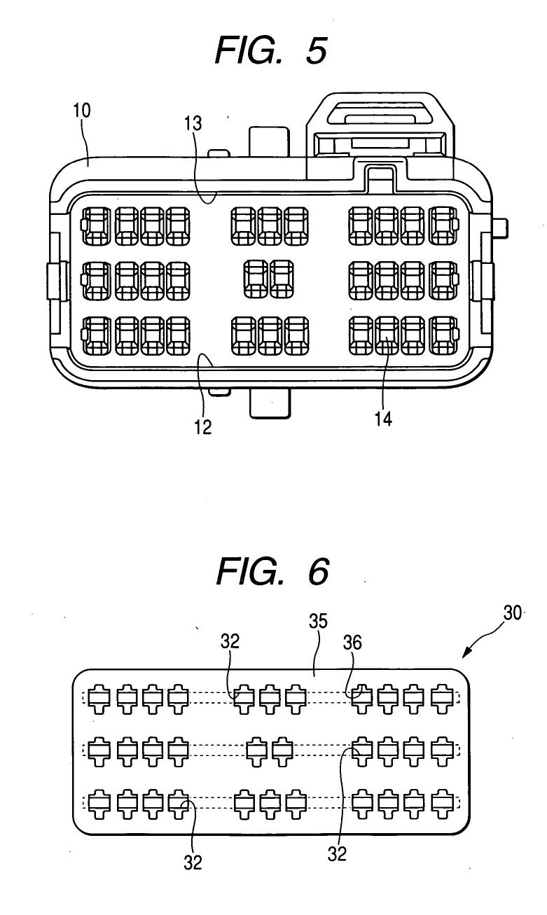

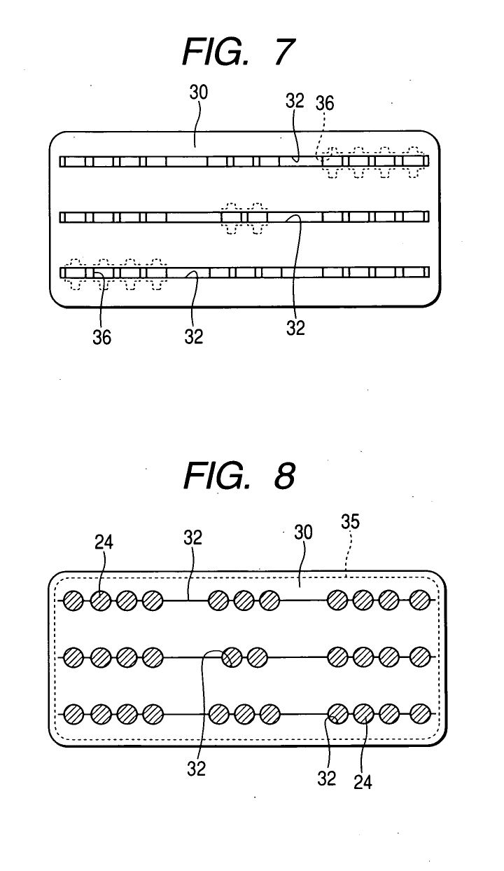

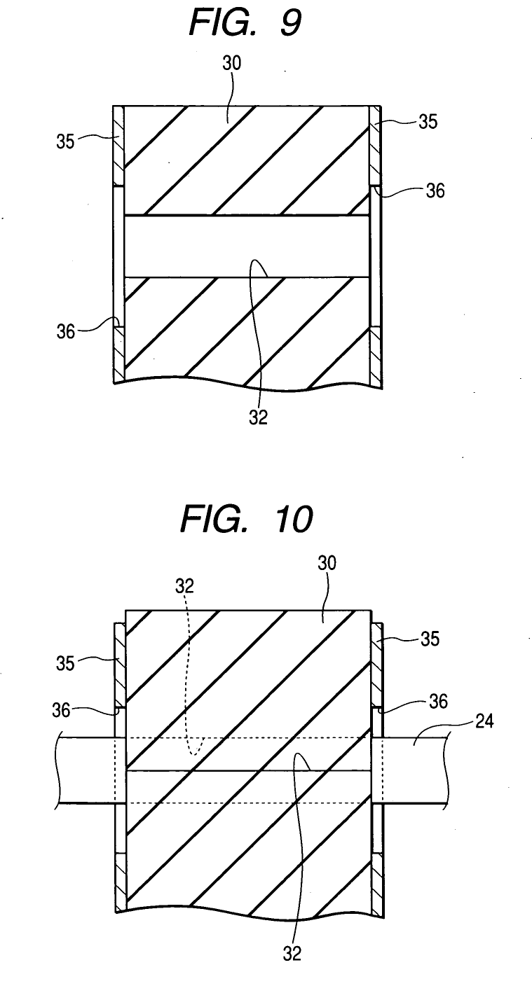

An explanation will be given of Embodiment 1 embodying the invention in reference to FIG. 1 through FIG. 10 as follows. A connector according to the embodiment is a male connector of a lumped waterproof type and is configured by including a housing 10, a plurality of terminal metal pieces 20, a lumped rubber plug 30 and a holder 40. Further, in the following explanation, a right side of FIG. 1 is made to configure a front side.

The housing 10 is formed in a block-like shape by a synthetic resin material, a front end portion thereof is formed with a hood portion 11 for fitting a counter female side connector (not illustrated), a rear end side thereof is formed with a containing recessed portion 12 for containing the lumped rubber plug 30 and the holder 40 to open to a rear side. The containing recessed portion 12 configures substantially a square shape four corners of which are formed in an arc-like shape when viewed from a rear side and a region on a depth side of an inner peripheral face of the containing recessed portion 12 is made to configure a seal face 13. Further, a depth end face of the containing recessed portion 12, that is, a face thereof with which a front end face of the lumped rubber plug 30 is brought into contact is made to configure a flat face orthogonal to a direction of inserting the terminal metal piece 20. Further, inside of the housing 10 is formed with a plurality of cavities 14 penetrated in a front and rear direction and opened to a depth end face of the hood portion 11 and the depth end face of the containing recessed portion 12 divided in three upper and lower stages and aligned (parallelly aligned) in one line in a left and right direction at each of the stages.

The terminal metal piece 20 is formed by pressing a metal plate excellent in conductivity and is configured by a shape of projecting a tab 22 at a front end of a cylindrical main body 21, and a barrel portion 23 at a rear end portion is brought into press contact with a distal end of an electric wire 24 by calking. The terminal metal piece 20 is inserted successively into a receiving hole 41 of the holder 40, mentioned later, and a slit 32 of the lumped rubber plug 30 and is inserted to the cavity 14 and is prevented from being drawn out by a resin lance 15 at inside of the cavity 14. Further, in a state of inserting the terminal metal piece 20 into the cavity 14, the electric wire 24 penetrates the slit 32 of the electric wire 24.

A depth side at inside of the containing recessed portion 12, that is, a space in correspondence with the seal face 13 is fitted with the lumped rubber plug 30. The lumped rubber plug 30 is formed in a shape of a laterally prolonged thick plate to be able to cover rear faces of the entire cavities 14, and a front end face thereof (a face in correspondence with the depth side face of the containing recessed portion 12) and a rear end face thereof (a face in correspondence with the holder 40) are made to configure flat faces orthogonal to a direction of inserting the terminal metal piece 20. The lumped rubber plug 30 is contained at inside of the containing recessed portion 12 while staying in a state of being not to be deformed elastically and in the contained state, an outer periphery of the lumped rubber plug 30 is not brought into contact with the seal face 13, or lightly brought into contact therewith to a degree of not substantially achieving a sealing function for the seal face 13.

Further, the lumped rubber plug 30 is formed with the slits 32 extended in a shape of a single straight line in the three upper and lower horizontal (left and right directions) to correspond to a group (line) of the cavities 14 parallelly aligned at an upper stage, a group (line) of the cavities 14 parallelly aligned at a middle stage and a group (line) of the cavities 14 parallelly aligned at the lower stage. The respective slits 32 are opened in a shape of a laterally prolonged window hole by penetrating the lumped rubber plug 30 in the front and rear direction. Further, although it is preferable that a dimension in an up and down direction of the slit 32 is smaller than a dimension of a height (dimension in an up and down direction) of the terminal metal piece 20 and substantially the same as an outer diameter of the electric wire 24 or a dimension slightly larger than the outer diameter, even when the dimension of the slit 32 in the up and down direction is made to be larger than the height dimension of the terminal metal piece 20, the waterproofing function is not hampered thereby.

The lumped rubber plug 30 comprises an elastic material having stickiness. As an elastic material having stickiness, a foamed material comprising acrylic species resin is used. As an example of a product which can be used for the lumped rubber plug 30, there is “3M Beta Tape” (registered trademark) of Sumitomo Three M K.K. Further, two front and rear faces of the lumped rubber plug 30 are laminated with sheets 35 (not illustrated in FIG. 1 through FIG. 4) which is not sticky and not elongatable and contractable. The sheet 35 is formed with a through hole 36 in correspondence with each of the cavities 14 in order to avoid interference in penetrating the lumped rubber plug 30 by the terminal metal piece 20.

Further, although according to the embodiment, an outer peripheral edge of the sheet 35 is in a mode of matching an outer peripheral edge of the lumped rubber plug 30, there may be configured a mode in which the outer peripheral edge of the sheet 35 is smaller than the outer peripheral edge of the lumped rubber plug 30 or a mode in which the outer peripheral edge of the sheet 35 is larger than the outer peripheral edge of the lumped rubber plug 30. In the case in which the outer peripheral edge of the sheet 35 is larger than the outer peripheral edge of the lumped rubber plug 30, when there is configured a mode in which the outer peripheral edge of the sheet 35 is matched to an inner periphery of the containing recessed portion 12, the lumped rubber plug 30 contained at inside of the containing recessed portion 12 can be positioned in an up and down direction and in a left and right direction (directions orthogonal to a direction of integrating the lumped rubber plug 30 to the containing recessed portion 12).

The holder 40 is fitted to an inlet side at inside of the containing recessed portion 12, that is, a space rearward from a region of containing the lumped rubber plug 30. The holder 40 is made of a synthetic resin and is formed in a shape of a laterally prolonged thick plate to be able to fit to the containing recessed portion 12 substantially tightly, further, a front end face of the holder 40 is made to configure a flat face orthogonal to the direction of inserting the terminal metal piece 20 and is made to be able to be brought into contact with a rear end face of the lumped rubber plug 30 (sheet 35) uniformly substantially over an entire region thereof. Further, the holder 40 is formed with the receiving hole 41 for enabling to penetrate the plurality of terminal metal pieces 20 in correspondence with the slits 32 of the lumped rubber plug 30 to penetrate in the front and rear direction.

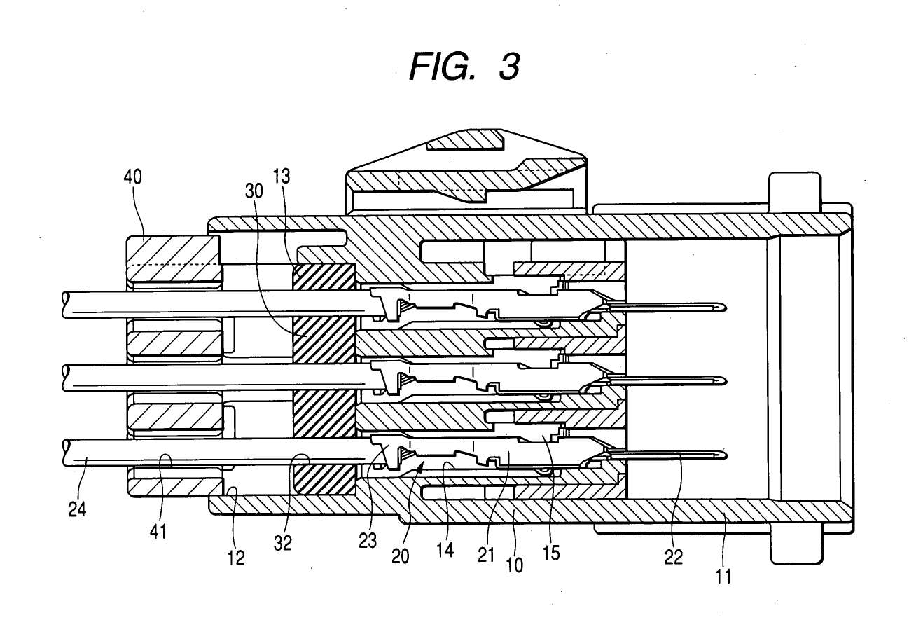

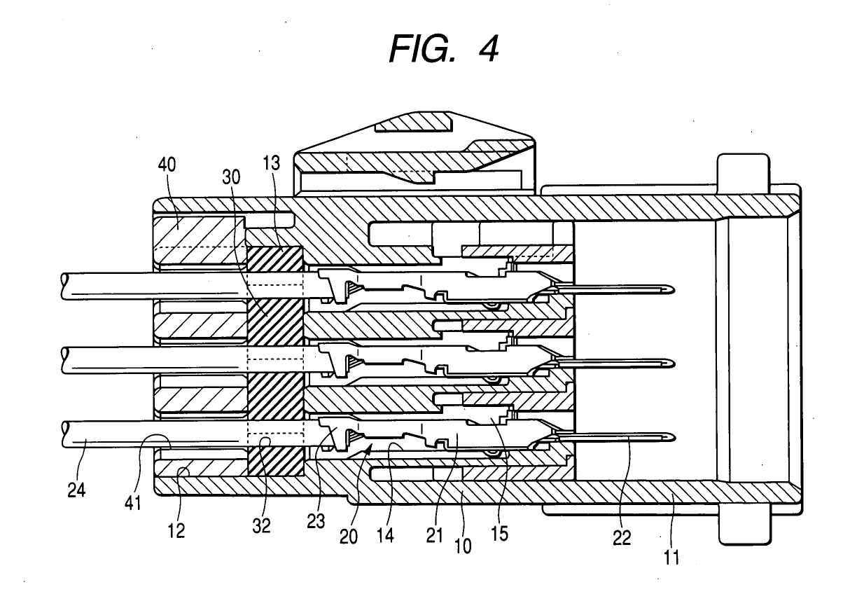

The holder 40 is made to be held at an actual locking position (refer to FIG. 4) of being brought into contact with the rear end face of the lumped rubber plug 30 contained in the containing recessed portion 12 (sheet 35) and at a tacked locking position (refer to FIG. 3) remote rearward from the lumped rubber plug 30 by a predetermined dimension. Further, as holding member therefor, there can be used a well-known structure in which, for example, locking pieces formed at two left and right portions of the holder 40 are locked by twos of front and rear locking projections for tacked locking and for actual locking formed at two left and right outer side faces of the housing 10.

Next, operation and effect of the embodiment will be explained.

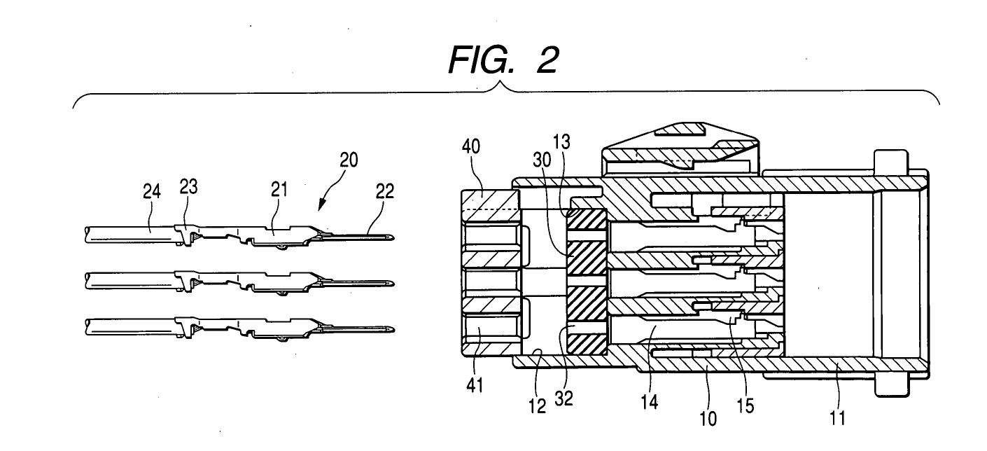

In integrating the connector, first, the lumped rubber plug 30 is contained to the depth side of the containing recessed portion 12 in a state of not being compressed (a state of not being elastically deformed) (refer to FIG. 2). Thereafter, the holder 40 is tackedly locked to the housing 10 (refer to FIG. 2). Under the state, the holder 40 is brought into a state of being remote rearward from the lumped rubber plug 30 and therefore, the lumped rubber plug 30 is not elastically deformed by the holder 40. Therefore, the respective slits 32 of the lumped rubber plug 30 are not positionally shifted in an up and down direction relative to the groups of the cavities 14 at the corresponding stages and the group of the receiving holes 41 of the holder 40, respectively.

From such a state, the terminal metal pieces 20 fixedly attached to the distal ends of the electric wires 24 are inserted into the respective receiving holes 41 of the holder 40, and are inserted into the cavities 14 by penetrating the through holes 36 of the sheets 36 on rear sides, the slits 32 of the lumped rubber plug 30, and the through holes 36 of the sheets 35 on front sides (refer to FIG. 3). When all of the terminal metal pieces 20 have been finished to insert, the holder 40 disposed at the tacked locking position is pressed to a front side to move to the actual locking position.

In a procedure of moving the holder 40 from the tacked locking position to the actual locking position, immediately before reaching the actual locking position, the front end face of the holder 40 is brought into contact with the rear end face of the lumped rubber plug 30 (sheet 35 on rear side), and during a time period of moving to the actual locking position from the state, the holder 40 elastically deforms the lumped rubber plug 30 to compress (crush) in the front and rear direction (an axis line direction of the electric wire 24) between the holder 40 and the depth end face of the containing recessed portion 12. In a state of maintaining the holder 40 at the actual locking position, the lumped rubber plug 30 crushed in the front and rear direction by being pressed by the holder 40 is elastically deformed to expand in the up and down direction and in the left and right direction (directions orthogonal to the axis line direction of the electric wire 24), that is, to displace an outer periphery of the lumped rubber plug 30 to the outer side (refer to FIG. 8). Thereby, the outer periphery of the lumped rubber plug 30 is brought into close contact with the seal face 13 of the inner periphery of the containing recessed portion 12 without a clearance therebetwween by an elastic recovery force of the lumped rubber plug 30 and a sticking force provided to the lumped rubber plug 30.

Further, in accordance with compressing the lumped rubber plug 30 in the front and rear direction, a width of an opening in the up and down direction of the slit 32 is narrowed, at a region at which the electric wire 24 is present, two upper and lower faces of the slit 32 are brought into close contact with an outer periphery of the electric wire 24 without a clearance therebetween by the elastic recovery force of the lumped rubber plug 30 and the sticking force provided to the lumped rubber plug 30 while being elastically deformed to follow (to be along) an outer peripheral shape in a semicircular arc shape thereof and at a region at which the electric wire 24 is not present, the upper face and the lower face of the slit 32 are brought into close contact with each other without a clearance therebetween (refer to FIG. 8). Thereby, the clearance between the lumped rubber plug 30 and the electric wire 24 is sealed.

As described above, according to the embodiment, the lumped rubber plug 30 brought into close contact with the outer periphery of the electric wire 24 to seal is configured by the elastic material having the stickiness and therefore, the clearance between the lumped rubber plug 30 and the electric wire 24 can firmly be prevented from being brought about by the sticking function. Further, the silicone gel material is not used as the material of the lumped rubber plug 30 and therefore, when used for a long period of time under an environment at high temperature, a deterioration of the water proofing function caused by using the silicon gel material can be avoided.

Further, since the lumped rubber plug 30 is configured by the sticky material made of acrylic species resin, the highly stable waterproofing function can be achieved under an environment requesting weather resistance and heat resistance.

Further, according to the lumped rubber plug comprising the silicone gel material, sealing is carried out by filling the clearance between the lumped rubber plug and the electric wire by oil impregnated in the silicone gel and therefore, although there is a concern of deteriorating the sealing performance owing to denaturing and flowing out the oil, according to the embodiment, sealing is carried out by directly bringing the sticky material made of acrylic species resin into close contact with the outer periphery of the electric wire 24 by the sticking force of its own and therefore, the sealing function can be maintained for a long period of time.

Further, since the lumped rubber plug 30 is configured by the foamed material and therefore, a sufficient thickness can be ensured in the axis line direction of the electric wire 24 and the waterproofing function can be promoted by widening an area of sticking to the electric wire 24 by that amount. Further, by having the lumped rubber plug by the foamed material, an amount of elastically flexing the lumped rubber plug 30 can sufficiently be ensured and therefore, the lumped rubber plug 30 can firmly be brought into close contact even with the electric wire 24 having a large outer diameter.

Further, since the lumped rubber plug 30 is deformed to compress to crush in the axial direction of the electric wire 24 and therefore, a degree thereof of being brought into close contact with the electric wire 24 is increased and the sealing performance can be promoted.

Further, by forming the slits 32 along the direction of aligning the cavities 14 at the lumped rubber plug 30, in inserting the terminal metal pieces 20 to the cavities 14, positions of the cavities 14 can be grasped by optically observing the slits 32 and therefore, operability in inserting the terminal metal pieces 20 into the cavities 14 is excellent.

Further, in drawing out the terminal metal pieces 20 inserted into the cavities 14 once, when the slits 32 are brought into an opened state by escaping the holder 40 to the tacked locking position, paths of drawing out the terminal metal pieces 20 are widened and operability in drawing out the terminal metal pieces 20 is excellent. Further, the clearance of the slit 32 is eliminated by crushing the lumped rubber plug 30 between the housing 10 and the holder 40 and therefore, the sealing performance is not deteriorated.

<Other Embodiments>

The invention is not limited to the embodiment explained by the above-described description and the drawings but, for example, the following embodiments are also included in the technical range of the invention, further, the invention can be embodied by being modified variously within the range not deviated from the gist other than described below.

(1) Although according to the embodiment, an explanation has been given of the connector for the male terminal metal piece having the tab at the front end, the invention is applicable also to a connector for a female terminal metal piece.

(2) Although according to the above-described embodiment, the lumped rubber plug is configured by the sticky material made of acrylic species resin, according to the invention, the lumped rubber plug may be configured by a sticky material comprising a resin other than acrylic species.

(3) Although according to the above-described embodiment, the lumped rubber plug is configured by the foamed material, according to the invention, the lumped rubber plug may be configured by a sticky material which is not a foamed material.

(4) Although according the above-described embodiment, the lumped rubber plug is formed with the slit, according to the invention, there may be configured a mode in which a slit is not formed.

(5) Although according to the above-described embodiment, the lumped rubber plug is formed with the slit, according to the invention, the lumped rubber plug may be formed with a small hole or a pin hole to penetrate therethrough in place of the slit.

(6) Although according to the above-described embodiment, the lumped rubber plug is pinched between the housing and the holder to elastically compressed to deform, according to the invention, the lumped rubber plug may be brought into a state of not being deformed elastically.

(7) Although according to the above-described embodiment, projected portions 11 and each of the press contact grooves 13 is opened to outside at respective upper and two front and rear side faces thereof.

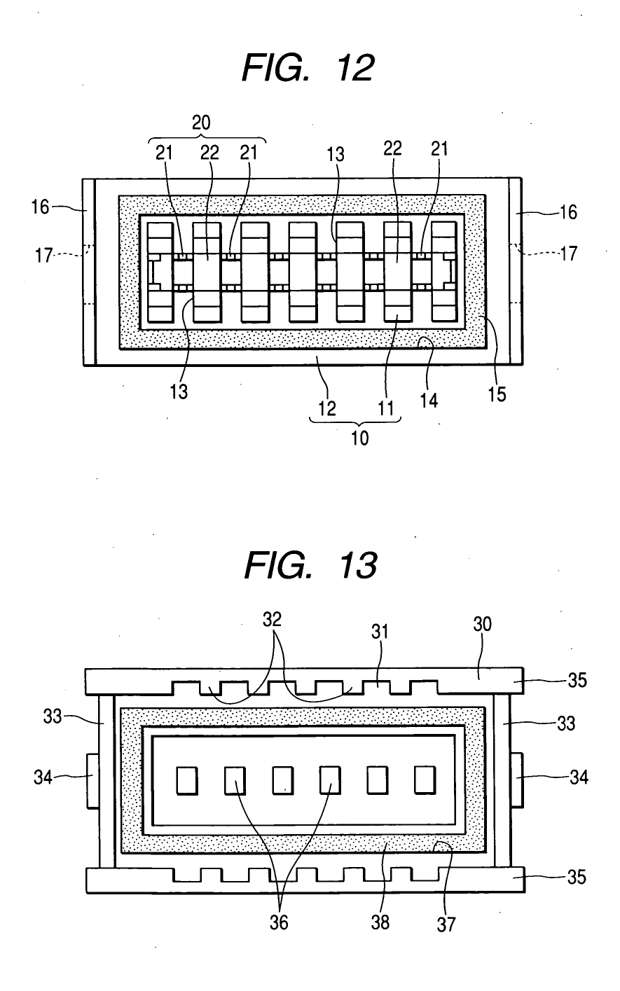

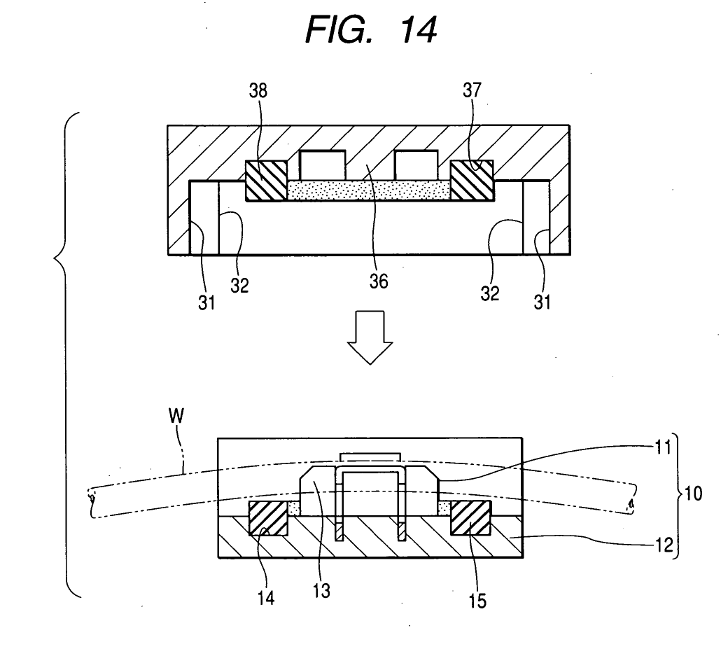

As shown by FIG. 12, a region along an outer peripheral edge of an upper face of the base seat portion 12 is formed with a seal groove 14 in a shape of a square ring to surround a group of the supporting projected portions 11 over an entire periphery thereof. The seal groove 14 is mounted with the housing side seal member 15 having a shape of a square frame (ring-like shape). As shown by FIG. 14, an upper portion of the housing side seal member 15 attached to the seal groove 14 is projected upward from the upper face of the base seat portion 12 and is made to be opposed to the cover side seal member 38 of the cover 30, mentioned later.

Two left and right ends of the base seat portion 12 are formed with lock portions 16, 16 in a shape of a wall elastically flexible to outer sides. The lock portion 16 is formed with a locking hole 17 engageable with a locking projection 34 of the cover 30, mentioned later, and the case 10 and the cover 30 are locked in an integrated state by engaging the locking hole 17 and the locking projection 34.

The joint terminal 20 is formed by punching and bending a metal plate member comprising a conducting material in a predetermined shape. The joint terminal 20 comprises a plurality of pairs of press contact blades 21 having the pairs there is constructed a mode in which the slit is opened in a window-like shape in a state in which the lumped rubber plug is not compressed to deform, according to the embodiment, there may be constructed a mode in which the slit is not opened in a cut-like shape, that is, window-like shape in a state in which the lumped rubber plug is not compressed to deform.

(8) The lumped rubber plug may be configured by laminating a plurality of sheets of sticky members having a plate-like shape in a plate thickness direction according to the embodiment.

(9) The dimension of the slit in the up and down direction may be configured by a dimension smaller than the outer diameter of the electric wire according to the embodiment.

<Embodiment 2>

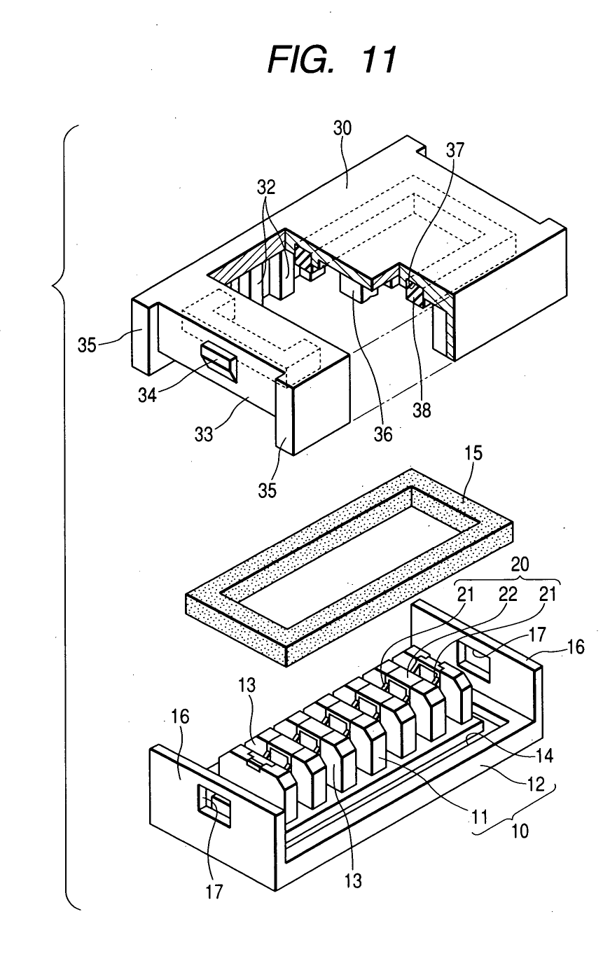

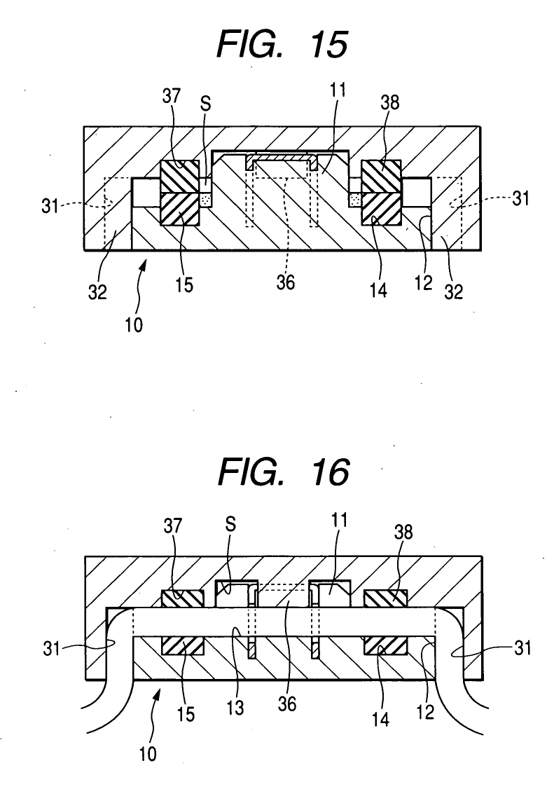

Embodiment 2 embodying the invention will be explained in reference to FIG. 11 through FIG. 16 as follows.

A press contact connector according to the embodiment is configured by a case 10, a joint terminal 20, a cover 30, a housing side seal member 15 and a cover side seal member 38 having sealing member.

The case 10 comprises a synthetic resin material and is configured by a mode of aligning a plurality of supporting projected portions 11 in a left and right direction on an upper face of a base seat portion 12 having a shape of a slender square plate in the left and right direction as a whole. A press contact groove 13 is configured between contiguous ones of the supporting in the front and rear direction by having substantially a “U”-like shape opened to an upper side, and a plurality of connecting portions 22 for connecting contiguous ones of the press contact blades 21, 22 in an attitude by which plate faces thereof become horizontal. The joint terminal 20 is attached to the case 10 in a state of arranging the respective pairs of press contact blades 21, 21 at front end positions and rear end positions in the press contact grooves 13 and bringing the connecting portions 22 into close contact with the supporting projected portions 11.

When an electric wire W is pressed into the press contact groove 13 to the case 10 in a state of attaching the joint terminal 20, a cover of the electric wire W is cut to open by the press contact blade 21, the press contact blade 21 is brought into contact with a core line thereof to be able to conduct electrically, and all of the electric wires W pressed into the respective press contact grooves 13 by the connecting portions 22 for connecting the press contact blades 21, 22 are connected to shortcircuit to be able to conduct electrically. The electric wire W fitted to the press contact groove 13 is made to be led out to outside of the case 10 by crossing the housing side seal member 15.

The cover 30 comprises a synthetic resin material and is configured by a shape of a box only a lower face of which is opened and is integrated to the case 10 to cover the supporting projected portions 11. Two front and rear edges (edges in a longitudinal direction) in opening edges of four sides of the lower face of the cover 30 open electric wire lead out spaces 31 for inserting the electric wires W between the two front and rear edges and two front and rear outer side faces of the base seat portion 12 in a state of being integrated to the case 10.

Inner faces of the two front and rear edges of the cover 30 are formed with electric wire guiding portions 32 opening pertinent intervals therebetween in a longitudinal direction thereof and projected from a plurality of positions which do not correspond to opening portions of the press contact grooves 13 to the two front and rear outer side faces of the base seat portion 12. By the electric wire guide portion 32, the electric wire W extended from the press contact groove 13 is prevented from being bent in either of left and right directions. Meanwhile, two left and right edges 33 of the lower face of the cover 30 are notched to dispose at positions higher than the two front and rear edges and are made to be brought into contact with positions between the seal groove 14 and the lock portion at the upper face of the base seat portion 12 in the state of being integrated to the case 10.

Outer side faces of two left and right ends of the cover 30 are formed to project with the locking projection 34 engageable with the locking hole 17 of the lock portion 16 from inner sides thereof and pairs of guide portions 35, 35 disposed to interpose the locking projections 34. In integrating the cover 30 to the case 10, the cover 30 is positioned in the left and right direction by bringing the two left and right outer side faces of the cover 30 into contact with the inner faces of the lock portions 16 and is positioned in the front and rear direction by bringing the two guide portions 35, 35 into sliding contact with two side faces of the lock portions 16, thereby, the cover 30 is integrated to the case 10 by being moved in parallel therewith while maintaining a constant attitude relative thereto.

Further, in the state of integrating the case 10 and the cover 30, the case 10 and the cover 30 are locked undetachably by engaging the locking projections 34 and the locking holes 17. Further, when the lock portions 16 are elastically deformed to outer sides in the locked state, the locking holes 17 are detached from the locking projections 34 and therefore, the cover 30 can be removed from the case 10.

A ceiling face in the cover 30 is formed with a plurality of press contact projections 36 capable of advancing into the respective press contact grooves 13 in accordance with integration to the case 10. The press contact projection 36 is provided with a function of making the electric wire W along the press contact groove 13 and pressing the electric wire W mounted at an upper position thereof into the press contact groove 13.

Similarly, the ceiling face in the cover 30 is formed with a seal groove 37 in a shape of a square ring to correspond with the seal groove 14 of the base seat portion 12 in the state of being integrated to the case 10. The seal groove 37 is mounted with the housing side seal member 38 having the shape of the square frame (ring-like shape). A lower end portion of the cover side seal member 38 attached to the seal groove 37 is projected downward from the sealing face of the cover 30 to be opposed to the housing side seal member 15 on a side of the case 10.

Both of the housing side seal member 15 and the cover side seal member 38, mentioned above, comprise an elastic material having a stickiness. As the elastic member having the stickiness, a foamed material comprising acrylic species resin is used. As an example of the product capable of being used for the housing side seal member 15 and the cover side seal member 38, there is “3M Beta Tape” (registered trade mark) of Sumitomo Three M K.K.

Next, operation of the embodiment will be explained.

In brining the electric wire W into press contact therewith, first, the electric wire W is shallowly fitted to each of the press contact grooves 13 by directing the electric wire W in the front and rear direction. Further, the cover 30 is lightly covered on the case 10 to make the two left and right outer side faces of the cover 30 correspond to the lock portions 16 of the case 10 and to fit the guide portions 35, 35 to the both sides of the lock portions 16 and the cover 30 is strongly pressed down to integrate to the case 10 from the state. In accordance therewith, the electric wire W is deeply pressed into the press contact groove 13 by the press contact projection 36 of the cover 30, the press contact blade 21 cut to open the cover to be brought into contact with the core line, thereby, all of the electric wires W fitted into the respective press contact grooves 13 are brought into the state of capable of conducting electrically to each other via the joint terminal 20.

When the lower ends 33 of the two left and right side walls of the cover 30 are brought into contact with the upper face of the base seat portion 12, the cover 30 cannot be pressed down further and at the same time, the locking projections 34 and the locking holes 17 are engaged with each other. Thereby, the case 10 and cover 30 are finished to integrate and the cover and the case 10 are locked undetachably. Further, portions of the electric wires W extended from the press contact grooves 13 are bent in lower directions from the upper face of the base seat portion 12 along the two front and rear side faces and are led out to outside from the bottom face side by passing the electric wire lead out spaces 31.

In the integrated state, the housing side seal member 15 and the seal member 38 on the side of the cover 30 are elastically compressed to deform in the up and down direction (direction of squeezing the electric wire W) and press-contacted portions of the electric wires W and the press contact blades 21 are sealed by the housing side seal member 15 and the seal member 38 on the side of the cover 30.

That is, at a portion of the path in the ring-like shape formed with the housing side seal member 15 at which the electric wire W is not present, faces of the both seal members 15, 38 opposed to each other are brought into close contact with each other without a clearance therebetween by sticking forces provided to the seal members 15, 38 and elastic recovery forces of the seal members 15, 38. On the other hand, at a portion thereof at which the electric wire W is present, the both seal members 15, 38 are brought into close contact with an outer periphery of the electric wire W while being elastically deformed to follow (to be along) the shape of the outer periphery in a semicircular arc shape by the sticking forces provided to the seal members 15, 38 and the elastic recovery forces of the seal members 15, 38. By the above-described operation, inside of a space S configured by incorporating the joint terminal 20 by the case 10 and the cover 30 is sealed in a watertight state by the both seal members 15, 38 to thereby prevent water from invading from outside into the space S.

As described above, according to the connector of the embodiment, the electric wire W is brought into press contact with the press contact blade 21 attached to the case 10 the upper face of which is opened, the cover 30 is covered on the upper face of the case 10 to cover to conceal the press contact portions of the press contact blade 21 and the electric wire W, the press-contacted electric wire W is elastically squeezed between the housing side seal member 15 provided to surround the group of press contact blades 21 at the upper face of the case 10 and the cover side seal member 38 provided to correspond to the housing side seal member 15 at the lower face of the cover 30 and the housing side seal member 15 and the cover side seal member 38 comprise the elastic member having the stickiness. Thereby, the elastic material having the stickiness is brought into close contact with the outer periphery of the electric wire W, and the clearance between the outer periphery and the housing side seal member 15 and the clearance between the outer periphery and the cover side seal member 38 are firmly prevented from being brought about by the sticking function.

Further, since the silicone gel material is not used for materials of the seal members 15, 38, when used for a long period of time under an environment at high temperature, a deterioration of the waterproofing function caused by using the silicon gel material can be avoided.

Further, since the housing side seal member 15 and the cover side seal member 38 are configured by the sticking material made of acrylic species resin, highly stable water proofing function can be achieved under an environment requesting weather resistance and heat resistance.

Further, whereas according to the seal member comprising the silicone gel material, sealing is carried out by filling the clearance between the seal member and the electric wire by oil impregnated in the silicon gel and therefore, there is a concern of deteriorating the sealing performance owing to denaturing or flowing out the oil, according to the embodiment of the application, sealing is carried out by directly bringing the sticky material made of acrylic resin into close contact with the outer periphery of the electric wire by the sticking force of its own and therefore, the sealing function can be maintained for a long period of time.

Further, by having the housing side seal member 15 and the cover side seal member 38 by the foamed material, an amount of elastically flexing the seal members 15, 38 can sufficiently be ensured and therefore, the seal members 15, 38 can firmly be brought into close contact even with the electric wire W having a large outer diameter.

Further, since the housing side seal member 15 and the cover side seal member 38 are compressed to deform to crush in a direction the same as the direction of squeezing the housing side seal member 15 and the cover side seal member 38 to the electric wire W, the degree of bringing the housing side seal member 15 and the cover side seal member 38 into close contact with the electric wire W is increased and the sealing performance is promoted.

<Other Embodiments>

The invention is not limited to the embodiment explained by the above-described description and the drawings but, for example, also the following embodiments are included in the technical range of the invention, further, the invention can be embodied by being modified variously within the range not deviated from the gist other than described below.

(1) Although according to the above-described embodiment, the housing side seal member and the cover side seal member are configured by the sticky material made of acrylic species resin, according to the invention, the housing side seal member and the cover side seal member may be configured by a sticky member comprising a resin other than acrylic species.

(2) Although according to the above-described embodiment, the housing side seal member and the cover side seal member are configured by the foamed material, according to the invention, the housing side seal member and the cover side seal member may be configured by a sticky material which is not a foamed material.

(3) Although according to the above-described embodiment, the housing side seal member and the cover side seal member are elastically deformed by being squeezed between the case and the cover, according to the invention, the housing side seal member and the cover side seal member may not be brought into a state of being deformed elastically.

(4) Although according the above-described embodiment, an explanation has been given of a case of forming the plurality of press contact blades at the single joint terminal, the invention is applicable also to a case of forming a press contact blade at a single terminal metal piece and connecting an electric wire to the terminal metal piece.

1. A connector comprising:
an electric wire; and
a housing having at least one part where the electric wire is lead out from the housing, wherein
the at least one part is at least partially made of an elastic material having a stickiness,
the elastic material independently seals the housing and the electric wire.

2. A connector according to claim 1, wherein
the housing further includes;
a lumped rubber plug; and
a terminal metal piece connected to the electric wire at a rear end thereof, wherein
the lumped rubber plug seals to be brought into close contact with an outer periphery of the electric wire, and
the at least one part of the housing is configured by the lumped rubber plug.

3. A connector according to claim 2, wherein
the terminal metal piece is inserted into the housing from a rear side while penetrating the lumped rubber plug.

4. A connector according to claim 2, wherein
the lumped rubber plug comprises a sticky material made of an acrylic species resin.

5. A connector according to claim 2, wherein
the lumped rubber plug comprises a foamed material.

6. The connector according to claim 2, wherein the lumped rubber plug is compressed to deform in an axis line direction of the electric wire between the housing and a holder.

7. A connector according to claim 6, wherein
the housing is formed with cavities aligning in at least one line, and
the lumped rubber plug is formed with slits along a direction of aligning the cavities.

8. A connector according to claim 7, wherein
the terminal metal piece is contained in the cavities.

9. A connector according to claim 1, wherein
the housing further includes;
at least one press contact blade that brings into press contact with the electric wire;
a cover having a cover side seal member at lower face thereof and covering upper opening face of the housing; and
a housing side seal member corresponding to the cover side seal member that surrounds the at least one press contact blade at the upper opening face of the housing,
wherein
the cover conceals a part where the electric wire is brought into press contact with the press contact blade,
the press-contacted electric wire is elastically pinched between the housing side seal member and the cover side seal member, and
the at least one part of the housing is configured by the housing side seal member and the cover side seal member.

10. A connector according to claim 9, wherein
the elastic material comprises a sticky material made of an acrylic species resin.

11. A connector according to claim 9, wherein the elastic material member comprises a foamed material.

12. A connector according to claim 9, wherein
the elastic material member is compressed to deform in a direction the same as a direction of pinching the press-contacted electric wire between the housing side seal member and the cover side seal member.

13. A connector according to claim 1, wherein
the elastic material comprises a sticky material made of an acrylic species resin.

14. A connector according to claim 1, wherein
the elastic material comprises a foamed material.

15. The connector according to claim 1, wherein
the elastic material is compressed to deform in a predetermined direction.
